(19) United States
(12) Patent Application Publication
(10) Pub. No.: US 2010/0327086 A1
(43) Pub. Date: Dec. 30, 2010

(54) Thermally efficient adhesive nozzle assembly

(76) Inventor: William Hassler, Elyria, OH (US)

Correspondence Address: William Hassler, 119 Vanderbilt Court, Elyria, OH, 44035, US

(21) Appl. No.: 12/459,080

(22) Filed: Jun. 26, 2009

(51) Int. Cl. B05B 1/00; B23P 11/00

(52) U.S. Cl. 239/589; 29/428

(57) ABSTRACT

The present invention pertains generally to a liquid control assembly wherein the assembly is useful in the placement of liquid dispersed at an angle, and more particularly, a nozzle assembly for directing thermal melt adhesive at an angle onto a desired target. The nozzle assembly includes a nozzle projection that exhibits a minimized effective radius and as such minimizes the temperature drop of the nozzle assembly with respect to the thermal melt extrusion head to which it is attached, thus retaining an operating temperature suitable for extrusion of thermal melt adhesives. The nozzle assembly further includes a two part inter-locking construction that allows for free axial rotation of the nozzle projection while retaining simplified assembly, maintenance, repair, and installation when used in conjunction with a thermal melt extrusion assembly.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

Application of thermal melt adhesive is an expeditious means for construction of products including consumer goods, component materials, and packaging. It is desirable to produce such products, as exemplified by cardboard boxes, on semi-automated and fully automated lines in large unit quantities per unit time. The ability to present thermal melt adhesive in a controlled manner, with minimal waste, contamination of adjacent surfaces (both on the material of construction as well as the production equipment itself) and appropriate flow rates is critical for attaining efficiency in the operation of a production line. For the purposes of this application, “thermal melt” adhesives shall include adhesives that either utilize an elevated temperature to induce a viscosity change in a stock supply of adhesive material (i.e. “hot” melt) or employs application of an elevated temperature to catalyze, induce, flash-off, or otherwise act upon a stock supply of material to render an adhesive performance (i.e. thermal set).

Prior art technologies have been developed to address finite control and placement of hot melt adhesives on at least partially automated manufacturing platforms. U.S. Pat. No. 4,469,248 to Petrecca includes a rotatable right-angled nozzle retained in an assembly retained by a snap ring and including a supplemental projection formed in the nozzle body which extends past an orifice tip. U.S. Pat. No. 5,887,757 to Jenkins et al., teaches an angled rotary nozzle assembly wherein the nozzle is retained in a mounting nut by opposing flange faces. U.S. Design Pat. No. D433,692 to Fort et al. depicts a nozzle design wherein a compound rectilinear form extends from the nozzle in a direction opposite a mounting or retaining nut. Each of the aforementioned patents are included by reference in their respective entireties.

The prior art nozzle assemblies are evident in their common citation of nozzle constructions utilizing significant material in the nozzle projection itself. Use of additional material in the construction of a nozzle projection, a nozzle projection that is required to operate under elevated operational temperatures, is undesirable in the fact that an increased amount of energy is required to obtain a desirable flow performance of a hot melt adhesive while overcoming the thermal conductive mass and additional exposed surface area of the nozzle construction itself. As “hot” melt adhesives are thermoplastic in nature, this type of adhesive undergoes initial softening as nozzle/extrusion assembly temperatures are increased in temperature. Further increases in operating temperature lead to the thermal adhesive adopting a liquid flow characteristic, which is ideal for automated production. Should the operating temperature of a nozzle/extrusion assembly exceed the flow characteristic necessary for the thermal melt adhesive to reach a liquid, flowable state, the thermal melt adhesive will begin to undergo thermal degradation and carbonization. Further, to obtain and maintain a flowable state of the thermal melt adhesive through an extrusion head and into a nozzle assembly, it is necessary to elevate the temperature of the entire assembly, including the mass associated with the nozzle itself. In the event the nozzle requires additional continuous thermal input to maintain a flowable state of the thermal melt adhesive, this additional thermal loading can lead to degradation of the thermal melt adhesive mentioned previously, leading to reduced adhesive performance and additional downtime associated with nozzles being obstructed with the degraded adhesive composition. This issue of excess thermal input requirement to achieve proper flow rates is yet further exacerbated by thermal melt adhesives that have varying flow properties at different, and often quite close, thermal ranges. For example, National Starch Insta Lok Type 34-2635 hot-melt adhesive has a listed viscosity of around 700 cps at 375 degrees F., 1150 cps at 350 degrees F., and around 1700 cps at 325 degrees F., wherein minor temperature fluctuations results in significant changes in flow characteristics. Thermal melt adhesive dispensed at a temperature significantly cooler than the system set point has a greater tendency to attach itself to the nozzle and accumulate on the nozzle surfaces, and upon reaching further accumulation, induces stringing of the thermal melt adhesive to other surfaces than where the adhesive is being dispensed. Accumulation of thermal melt adhesive on the dispensing nozzle and on the non-target regions of a product or material surface requires additional time to remove the contaminating material and to return the system to an operational state.

Prior art nozzle also exhibit a reliance on either non-decoupleable flanges or use of secondary retention means to maintain the nozzle assembly in a cohesive form prior to or after use on an extrusion head (i.e. during maintenance). Preformed flanges prevent the ready removal of a nozzle projection from a retaining nut, and must be counter bored to remove the nozzle associated flange in order to remove the nozzle projection in the event of replacement. In the alternative, nozzle assemblies utilizing a permanent flange construction are treated as irreparable components and thus are discarded once a useful life span is reached or if the nozzle projection becomes unrecoverably occluded. Use of removable plugs opposite the nozzle orifice have been included as a means for cleaning a clogged orifice, however, such plugs present additional thermal mass and surface area in the form of the plug itself and the means for retaining the plug on the nozzle projection, and thus present the above issue of increased heating requirements. Secondary retention means, such snap rings, “E”-clips and jam nuts, allow for a nozzle assembly to be deconstructed and for components therein to be replaced or remedied. Use of secondary retention means require additional elements to be included in the machined structure of the nozzle assembly, thus placing an increased demand on maintaining tight tolerances during construction and incorporation of additional steps in the manufacture, assembly, and maintenance of this type of nozzle design.

There remains an unmet need for a nozzle assembly which presents a more favorable near-isothermal profile for extrusion of thermal melt adhesives thus allowing for less high temperature stress on the adhesive during use, provides less demand on equipment used to elevate and maintain an operational temperature, and is readily disassembled for cleaning, replacement and upkeep.

### SUMMARY OF THE INVENTION

The present invention pertains generally to a liquid control assembly wherein the assembly is useful in the placement of liquid dispersed at an angle, and more particularly, a nozzle assembly for directing thermal melt adhesive at an angle onto a desired target. The nozzle assembly includes a nozzle projection that exhibits a minimum mass and surface area, which is well within the critical radius of insulation and as such improves the thermal efficiency of the nozzle assembly to retain an operating temperature suitable for extrusion of thermal melt adhesives. When in an assembled form with a retaining nut, the nozzle projection presents a free length comprising the nozzle nose, wherein the nozzle nose extends away from a point where the nozzle projection and the retaining nut meet. The nozzle nose further comprises a cross-sectional diameter or width as measured at the point of greatest dimension. In accordance with the present invention the ratio of the nozzle nose free length to cross-sectional radius (defined as one-half of the diameter or width at the point of greatest cross-sectional dimension) is at least two to one. To operate the nozzle assembly, it is affixed to a means for producing a flow of thermal melt adhesive from a thermal melt adhesive stock.

In a further embodiment, a nozzle assembly includes a nozzle projection that exhibits an angled orifice through the nozzle nose. The angled orifice deviates from an axial flow tube within the nozzle projection at an angle of between 0 degrees and 135 degrees, preferably an angle within the range of 45 degrees to 135 degrees and most preferably an angle within 60 degrees and 100 degrees. The nozzle projection having minimum critical radii improves the thermal efficiency of the nozzle assembly to retain an operating temperature suitable for extrusion of thermal melt adhesives while allowing the nozzle to be oriented in a position other than perpendicular to the work surface. The nozzle assembly is affixed to means for producing a flow of thermal melt adhesive from a thermal melt adhesive stock.

In a further embodiment, the nozzle assembly further includes a two part inter-locking construction that allows for free axial rotation of the nozzle projection while retaining simplified maintenance, repair, and installation when used in conjunction with a thermal melt extrusion head. The inter-locking construction is of a nature such that a first profile defined by an exterior aspect of a nozzle projection engages upon a corresponding second reverse profile defined by an interior aspect of a retaining nut. So as to render a free-axial rotation between the retaining nut and nozzle projection, the first profile, the second profile or combinations of the first and second profile disengage from one another in a captive region within the nozzle assembly.

A further embodiment of the present invention, a nozzle assembly includes a nozzle projection that exhibits a minimum mass and surface area, which is well within the critical radius of insulation, thus allowing the nozzle assembly to retain an operating temperature suitable for extrusion of thermal melt adhesives. The nozzle projection is affixed to means for producing a flow of thermal melt adhesive from a thermal melt adhesive stock by way of a retaining nut. The nozzle assembly comprises a two part inter-locking construction that allows for free axial rotation of the nozzle projection while retaining simplified maintenance, repair, and installation when used in conjunction with a hot melt extrusion assembly. The inter-locking construction is of a nature such that a first profile defined by an exterior aspect of a nozzle projection engages upon a corresponding second reverse profile defined by an interior aspect of a retaining nut. To render a free-axial rotation between the retaining nut and nozzle projection, the first profile, the second profile or combinations of the first and second profile disengage in a captive region within the nozzle assembly.

In a further embodiment, a nozzle assembly includes a nozzle projection that exhibits a angled orifice through the nozzle nose that exhibits a minimum mass and surface area, which is well within the critical radius of insulation, thus allowing the nozzle assembly to retain an operating temperature suitable for extrusion of thermal melt adhesives. The angled orifice deviates from an axial flow tube within the nozzle projection at an angle of between 0 degrees and 135 degrees, preferably an angle within the range of 45 degrees to 135 degrees and most preferably an angle within 60 degrees and 100 degrees. The nozzle projection having a minimum mass and surface area improves the thermal efficiency of the nozzle assembly to retain an operating temperature suitable for extrusion of thermal melt adhesives while allowing the nozzle to be oriented in a position other than perpendicular to work surface. The nozzle projection is affixed to means for producing a flow of thermal melt adhesive from a thermal melt adhesive stock by way of a retaining nut. The nozzle assembly comprises a two part inter-locking construction that allows for free axial rotation of the nozzle projection while retaining simplified maintenance, repair, and installation when used in conjunction with a hot melt extrusion assembly. The inter-locking construction is of a nature such that a first profile defined by an exterior aspect of a nozzle projection engages upon a corresponding second reverse profile defined by an interior aspect of a retaining nut. To render a free-axial rotation between the retaining nut and nozzle projection, the first profile, the second profile or combinations of the first and second profile disengage in a captive region within the nozzle assembly.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The invention will be more easily understood by a detailed explanation of the invention including drawings. Accordingly, drawings which are particularly suited for explaining the inventions are attached herewith; however, it should be understood that such drawings are for descriptive purposes only and as thus are not necessarily to scale beyond the measurements provided. The drawings are briefly described as follows:

FIG. 1 is exterior perspective view of a nozzle assembly in accordance with the present invention wherein an integrated angled orifice is provided;

FIG. 2 is an exterior perspective view of a nozzle projection unit as shown in FIG. 1;

FIG. 3 is a front view of a nozzle assembly according to a preferred embodiment of the present invention wherein an integrated angled orifice is provided;

FIG. 4 is back view of a nozzle assembly as in FIG. 3;

FIG. 5 is a top down view of a nozzle assembly as in FIG. 3 wherein an orientation slot in the nozzle projection is depicted;

FIG. 6 is a bottom up view of a nozzle assembly as in FIG. 3 wherein an entrance to an axial flow tube is presented;

FIG. 7 is a front view depicting the spatial orientation of a nozzle projection and a retaining nut prior to production of a nozzle assembly as shown in final combination in FIG. 3;

FIG. 8 is a front view depicting the spatial orientation of a nozzle projection and a retaining nut prior to production of a nozzle assembly as shown in final combination in FIG. 3, wherein an assembly tool in inserted into the flange element of the nozzle projection;

FIG. 9 is a cross-sectional front view depicting the spatial orientation of a nozzle projection and a retaining nut prior to production of a nozzle assembly as shown in final combination in FIG. 3, wherein the secondary extensions of an assembly tool are inserted into the flange of a nozzle projection so as to position the nozzle projection and its associated first retention profile ultimately into engagement with the retaining nut second retention profile;

FIG. 10 is a cross-sectional side view depicting the spatial orientation of a nozzle projection and a retaining nut during nozzle assembly or disassembly; the nozzle projection first retention profile is engaged upon the retaining nut second retention profile;

FIG. 11 is a cross-sectional side view depicting the spatial orientation of a nozzle projection and a retaining nut after formation of the nozzle assembly; the nozzle projection first retention profile is disengaged from the retaining nut second retention profile and is captured within the retaining nut such that free axial rotation is imparted;

FIG. 12a is a cross-sectional side view of a preferred second retention profile comprising a continuous threaded profile;

FIG. 12b is a cross-sectional side view of an alternate second retention profile comprising a discontinuous or interrupted threaded profile;

FIG. 13 is a cross-sectional representation of a nozzle nose for determining critical radius of insulation, minimum surface area and minimum mass;

FIG. 14 is an alternate assembly tool design adapted for surface mounting;

FIG. 15 is an front view of a nozzle assembly in accordance with FIG. 3 wherein the assembly is affixed to a thermal melt extrusion head.

### LIST OF REFERENCE NUMERALS

Nozzle assembly 2, nozzle projection 10, nozzle nose 11, nozzle orifice 12, nozzle shoulder 14, nozzle flat 15, nozzle orientation slot 16, nozzle retention flange 17, axial flow tube 18, first retention profile 19; retaining nut 20, retaining nut shoulder 22, free axial rotation chamber 24, second retention profile 26, assembly tool 40, assembly tool mounting point 42, assembly tool secondary extensions 43, thermal melt extrusion head 50.

### DETAILED DESCRIPTION OF THE INVENTION

While the present invention is susceptible of embodiment in various forms, there is shown in the drawings and will hereinafter be described a presently preferred embodiment of the invention, with the understanding that the present disclosure is to be considered as an exemplification of the invention, and is not intended to limit the invention to the specific embodiment illustrated.

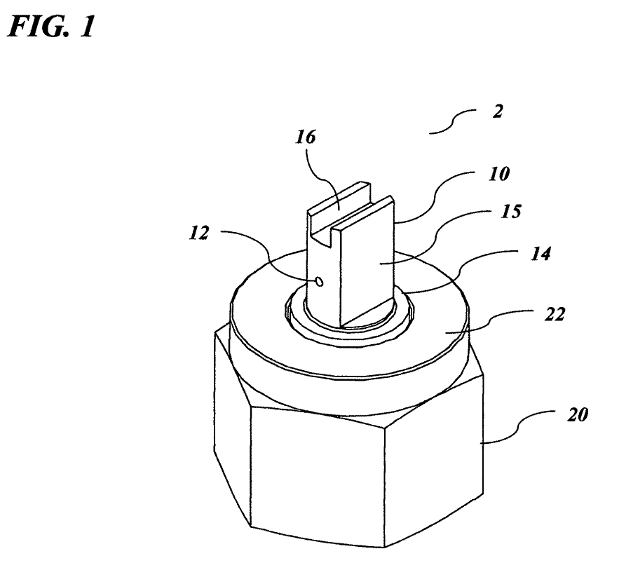

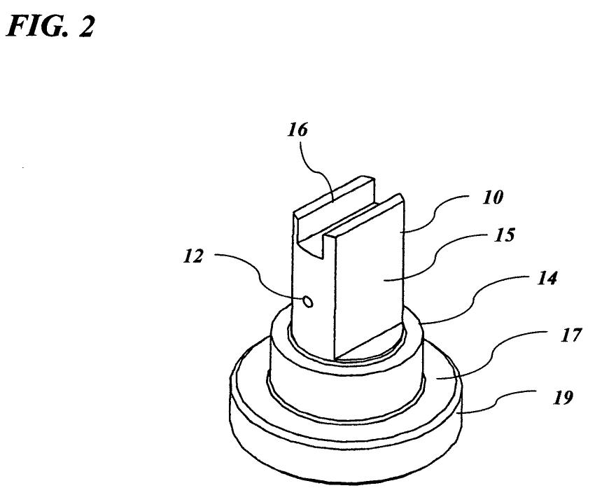

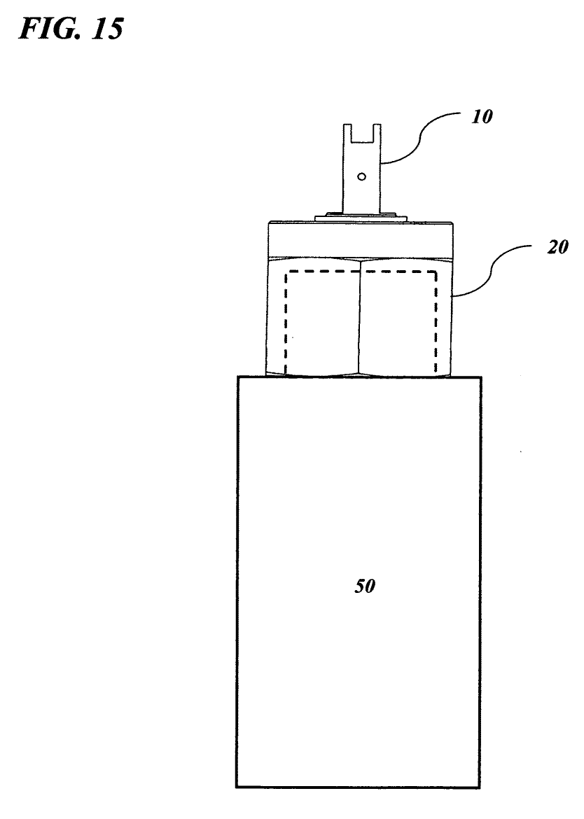

For illustrative purposes, the present invention is embodied in the apparatus generally shown in FIG. 1 through FIG. 15. Referring first to FIG. 1 and FIG. 2 the present invention pertains generally to a liquid control assembly wherein the assembly is useful in the placement of liquid dispersed at an angle, and more particularly, a nozzle assembly 2 for directing thermal melt adhesive at an angle onto a desired target through the combination of a nozzle projection 10 and a retaining nut 20. Nozzle projection 10 is formed of a thermally conductive material comprised of ferrous metals, non-ferrous metals, alloys, polymers, ceramics, glass, and combinations thereof. In a preferred embodiment the nozzle projection is formed as a monolithic brass structure, though combinations of nozzle elements to form a nozzle projection 10 is within the purview of the present invention. Retaining nut 20 is preferably formed of a thermally conductive material comprised of ferrous metals, non-ferrous metals, alloys, polymers, ceramics, glass, and combinations thereof. In a preferred embodiment the retaining nut 20 is formed as a monolithic brass structure, though combinations of retaining nut elements to form a retaining nut 20 is within the purview of the present invention. Nozzle projection 10 and retaining nut 20 may be formed of the same or differing materials, wherein any such material exhibits sufficient burst strength to allow for a safety margin over the operational pressure of an associated thermal melt extrusion head 50 (as depicted in FIG. 15).

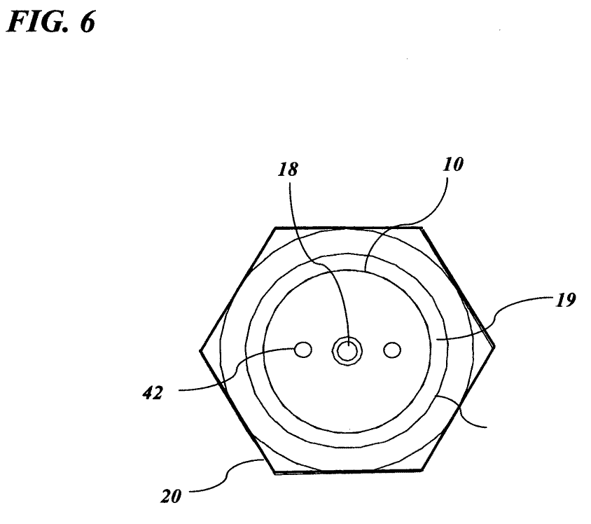

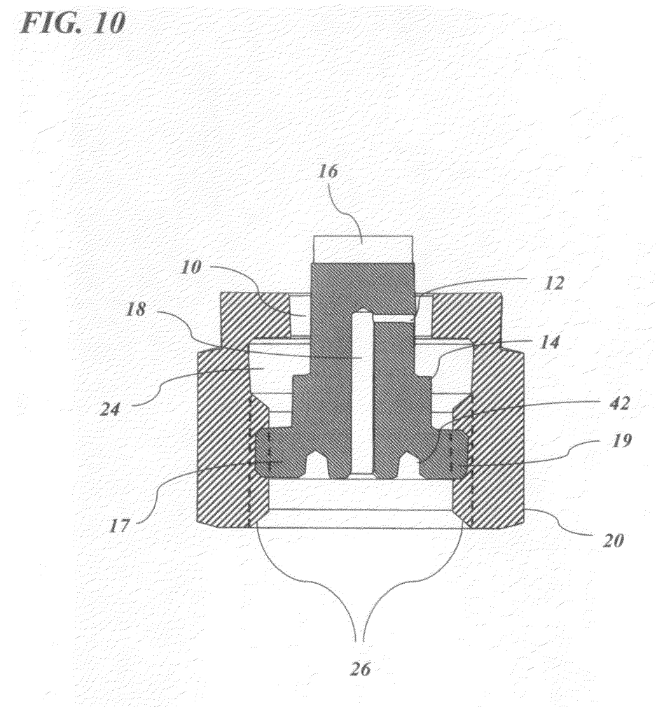

A lower physical aspect of nozzle projection 10 is comprised of a nozzle retention flange 17, an axial flow tube 18 (as depicted in detail in FIG. 6), a first retention profile 19, and a nozzle shoulder 14. Nozzle retention flange 17 has a profile of sufficient dimension to perform two primary functions; prevent the nozzle projection 10 from displacing through a distal opening in retaining nut 20 and to position the nozzle projection 10 in fluid communication between axial flow tube 18 and a thermal melt extrusion head 50. Circumferentially located on nozzle retention flange 17 are one or more first retention profile 19, whereupon first retention profile 19 act upon second retention profile 26 in retaining nut 20 (as depicted in detail in FIG. 10) to allow for captive placement of nozzle projection 10 in free axial rotation chamber 24. Nozzle shoulder 14 is of appropriate geometry to extend from nozzle retention flange 17 to a point in proximity to a retaining nut shoulder 22 in retaining nut 20. By positioning nozzle shoulder 14 through a hole defined in retaining nut shoulder 22, nozzle projection 10 is made resistant to lateral play or wobbling when affixed to a thermal melt extrusion head 50. In a preferred embodiment retaining nut 20 is affixed to said thermal melt extrusion head 50 by the same second retention profile 26.

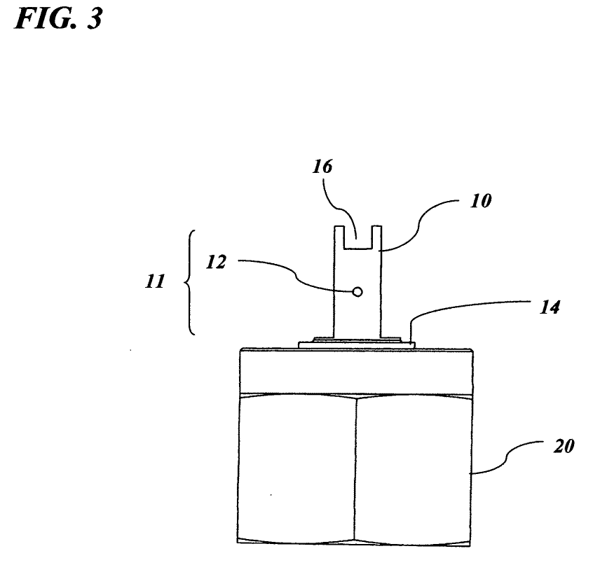

The nozzle assembly 2 includes a nozzle projection 10 that exhibits a cross-sectional perimeter which exhibits a minimum mass, minimum surface area and is within a minimum critical radius of insulation, and as such improves the thermal efficiency of the nozzle assembly 2 to retain an operating temperature suitable for extrusion of thermal melt adhesives. Nozzle projection 10 is preferably formed of a monolithic construction, and specifically formed out of a contiguous piece of brass, though alternate materials and compound constructions are within the purview of the present invention. Nozzle projection 10 exhibits an upper section comprising of nozzle nose 11 (FIG. 3), at least one nozzle orifice 12, orientation slot 16, continuation of axial flow tube 18 and optionally nozzle flat 15. Orientation slot 16 and optional nozzle flat 15 are in fixed alignment with at least one nozzle orifice 12.

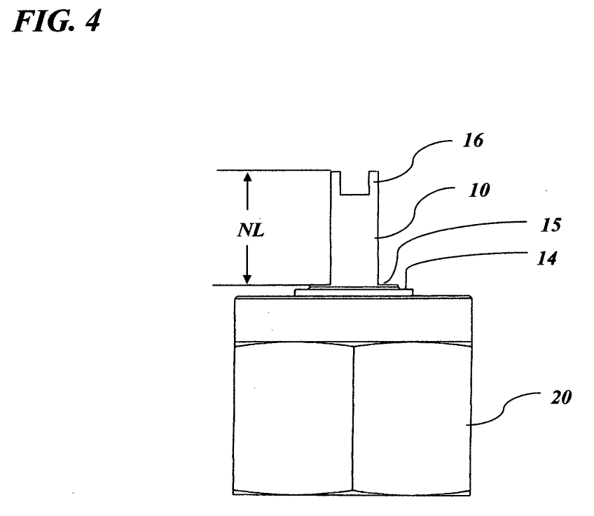

Nozzle nose 11 is specifically designed to reduce the thermal mass and exposed surface area embodied within the structure, and thus reduce the need for elevated temperatures required to operate the nozzle assembly 2 efficiently while limiting unnecessarily high heat flux through the structure. When in an assembled form with a retaining nut 20, the nozzle projection 10 presents a free length (“NL”) comprising the nozzle nose 11, wherein the nozzle nose 11 extends away from a point where the nozzle projection 10 and the retaining nut meet 20 (FIG. 4). Preferably, nozzle nose 11 is of a round cross-sectional profile as such a geometry is readily produced by axial-rotational machining (i.e. turned on an automated lathe), though rectilinear, compound rectilinear, curvilinear, compound curvilinear profiles and the combinations thereof are within the purview of the present invention. The nozzle nose further comprises a cross-sectional diameter or width as measured at the point of greatest dimension. In accordance with the present invention the ratio of the nozzle nose free length to cross-sectional nozzle radius (defined as one-half of the diameter or width at the point of greatest cross-sectional dimension, “NR” in FIG. 4.) is at least two to one. The present invention also anticipates the use of stepped or varied cross-sectional geometries wherein the cross-sectional profile changes continuously or discontinuously along the free length of the nozzle nose.

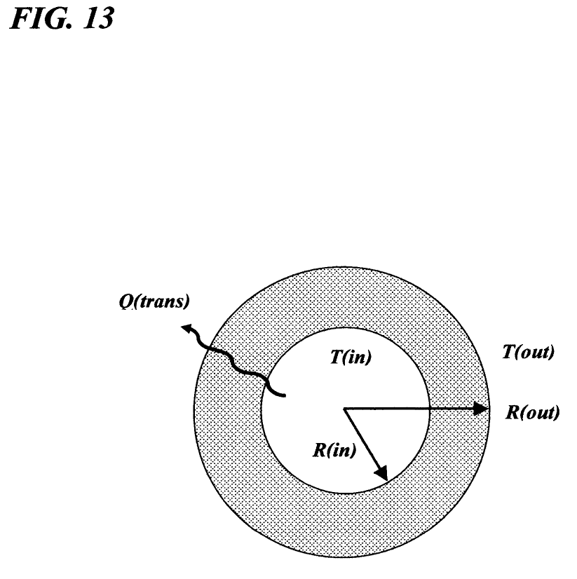

FIG. 13 is a detailed depiction of nozzle nose cross-section with assigned parametric variables. The nozzle nose 11 has an outer radius (“R[out]”) defined by the outer periphery of the cross-sectional profile as measured from a mid-axial point centered with an axis of symmetry. Within nozzle nose 11 is axial flow tube 18, which is in continuous fluid communication from a distal point within nozzle retention flange 17. The axial flow tube 18 is preferably positioned with an in an inner radius (“R[in]”) defined by the periphery of the cross-sectional profile as measured from a mid-axial point centered with an axis of symmetry. Axial flow tube 18 positioned such that it is centered within the nozzle nose 11 such that the difference of R[out] from R[in] is equidistant about the axis of symmetry.

For purposes of the present invention, a maximum R[out] is derived based on an algorithm for determining critical radius of insulation for a round cross-sectional tube, founded on Newton's law of cooling as applied to a steady-state, convective heat transfer rate per unit length from a bare cylinder (FIG. 13):

Q[trans]=(T[in])−T[final]]/(((ln(R[out]/R[in])/2*pi*K)+(1/(2*pi*R[out]*H[out])))

wherein:

Q[trans]=Heat transfer rate per unit length

T[in]=Temperature inside tube

T[out]=Temperature outside tube

R[in]=Inner tube radius

R[out]=Outer tube radius

K=Thermally conductivity of insulation

H[out]=Convective heat transfer coefficient of outside tube

As the nozzle nose 11 is generally a free-standing element from nozzle projection 10, H[out] is determined from the surrounding operating gaseous environment. K is derived from the material composition from which nozzle nose 11 is constructed. R[out] is then solved for to determined maximum diameter for nozzle nose 11, then the practical R[out] is determined based on the maximum degree by which the nozzle nose 11 can then be constructed. For example, is has been determined that for a nozzle nose 11 formed in brass having an R[in] of 0.0075 inch to 0.05 inch, an R[out] in the range of between 0.075 inch and 0.50 inch is indicated, and in a preferred range of R[in] of 0.015 inch to 0.05 inch, an R[out] in the range of between 0.12 inch and 0.40 inch is indicated. Converting the above example into relative measures of R[out] to R[in], nozzle nose having R[out] of less than ten (10) times R[in], and preferably R[out] less than eight (8) times R[in] being desirable for obtaining a nozzle nose 11 in a nozzle assembly 10 which provides optimal thermal efficiency while maintain proper thermal melt adhesive flow attributes.

To apply the above equation in practice of designing a nozzle assembly, first differentiate the Newton's law of cooling as applied to a steady-state, convective heat transfer rate per unit length from a bare cylinder with respect to R(out) to determine at what value of R(out) the heat transfer Q(trans) is at a maximum (i.e. when the derivative is equal to zero). The value for R(out) where Q(trans) is maximized turns out to be equal to K/H(out), or the critical radius of heat transfer. Values for R(out) greater or less than this number will result in a lower Q(trans). Applying the differential equation to a brass construct, which has a K of 115 Watts/(meter*Deg. K) and using an average film coefficient of heat transfer for free convection in air of 10 Watts/(meter´2*Deg. K) a substantial critical radius of heat transfer of 11.5 meters is calculated. Given the high efficiency of a brass construct, as evident from the significantly large critical radius, the driving design variables are then related to the surface area of the nozzle and a desire to optimize the wall thickness of the nozzle nose 11 to minimize heat loss. It is within the purview of the present invention that addition nozzle nose 11 wall material may be removed in support of reducing surface area and/or reducing wall thickness, such as presented in the form of one or more nozzle flat 15 as depicted in FIG. 1.

At a proximal termination point of axial flow tube 18 within nozzle nose 11, therein is defined at least one nozzle orifice 12. At least one nozzle orifice 12 is a controlled exit point for thermal melt adhesive supplied by a thermal melt extrusion head 50 into axial flow tube entrance within nozzle retention flange 17 and is controlled in orientation of dispersal by rotation of the entire nozzle projection 10 by way of user manipulation of orientation slot 16 through use of a screwdriver or like device and/or optionally by engaging nozzle flat 15. Nozzle orifice 12 forms a fluid communication path extending from axial flow tube 19 to an outer aspect of nozzle nose 11. The fluid communication path within nozzle orifice 12 may include various cross-sectional measures, geometries, and angles of departure from an axis of symmetry defined by axial flow tube 18. Preferred cross-section measures include radii, diameters or equivalent measures (i.e. width and length if of a rectilinear cross-sectional geometry) of between about 0.1 to 2.0 times the axial flow tube 18 diameter, preferably of between 0.1 and 1.0 times the axial flow tube 18 diameter, and most preferably between 0.2 and 0.5 times the axial flow tube diameter. Cross-sectional geometries of the at least one nozzle orifice 12 may be linear, angular, radiused, compound radiused and combinations thereof. The nozzle orifice 12 may be in line with the bore defined by the axial flow tube 18, or may depart from the central axis of the axial flow tube at an angle of between 0 degrees and 135 degrees, preferably an angle within the range of 45 degrees to 135 degrees and most preferably an angle within 60 degrees and 100 degrees. As depicted in the associated figures, a particularly desired nozzle orifice exhibits an angle of departure of 90 degrees. It is within the purview of the invention that one or more nozzle orifice 12 may extend from the proximal termination point of axial flow tube 18, wherein each nozzle orifice 12 may be of the same or differing geometries, at the same or differing departure angles as measured from the axis defined by the axial flow tube 18.

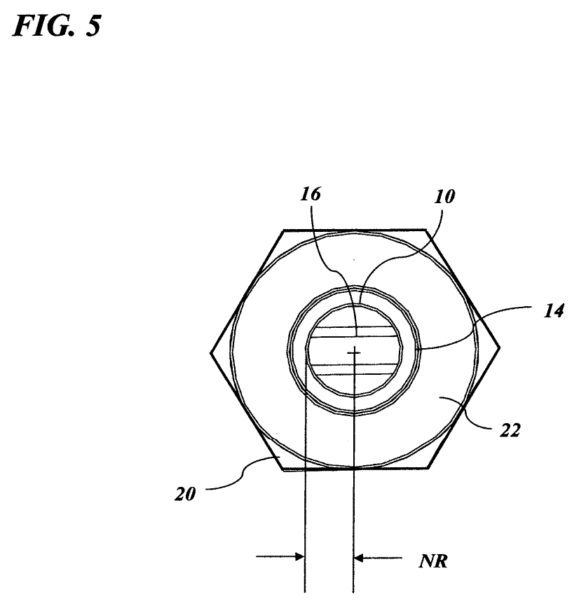

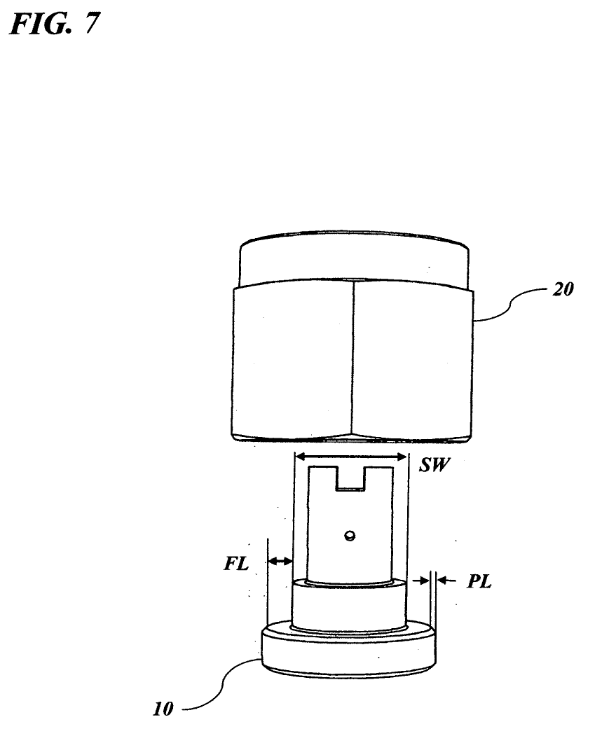

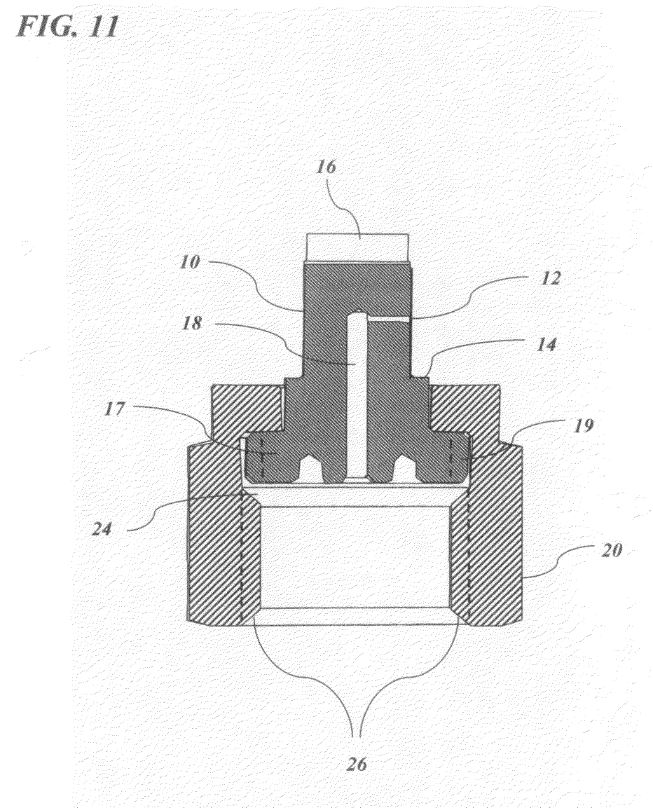

Retaining nut 20 is comprised of retaining nut shoulder 22, free axial rotation chamber 24 (FIG. 10), and second retention profile 26. Retaining nut shoulder 22 forms an inwardly extending structure with a void through a central aspect thereof. The central void is of an equivalent inner profile to correspond to a geometry imparted by an exterior profile of nozzle shoulder 14 (“SW”) as defined in FIG. 7, and for purposes of assembly tolerance, is larger than no more than one half of the difference of a first retention profile 19 (“PL”) subtracted from an upper engagement face of nozzle retention flange 17 (“FL”). Retaining nut 20 includes an outer surface profile, which is conducive for application of force, such as when installing a nozzle assembly 2 to a thermal melt extrusion head, as is typical in the industry this is performed with a standard 0.5 inch wrench (not shown). Depicted in the attached figures is a preferred embodiment wherein the retaining nut 20 exterior profile has a hexagonal perimeter shape (reference FIGS. 5 and 6). Within retaining nut 20 is a second retention profile 26, which engages upon the first retention profile 19 associated with nozzle projection 10. A preferred embodiment is shown FIG. 11, wherein second retention profile 26 terminates proximal to retaining nut shoulder 22 such that a region is defined in the interior of retaining nut 20, this region being defined as free axial rotation chamber 24. Free axial rotation chamber 24 allows for nozzle projection 10 to rotate about a central axis (through manipulation of orientation slot 16 and/or nozzle flat 15) without further engagement of the second retention profile 26.

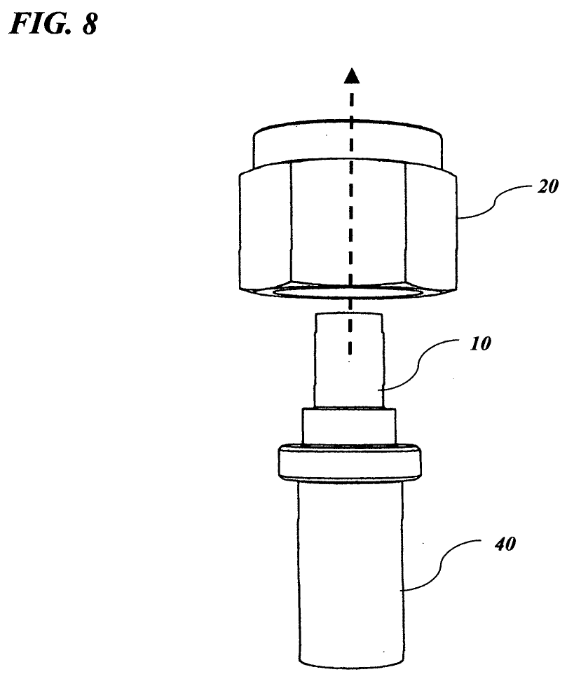

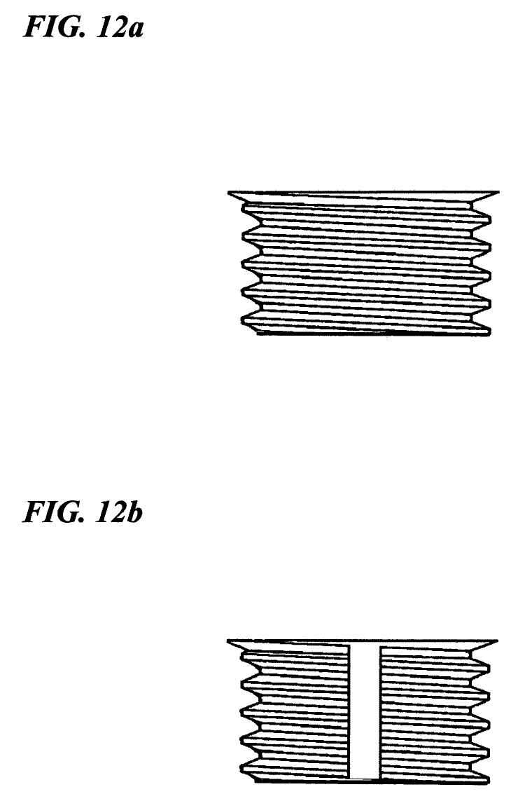

Referring now to FIG. 8 through 12b, therein is depicted in greater detail the function of free axial rotation chamber 24 and a preferred method by which nozzle assembly 2 is formed by attachment of nozzle projection 10 within retaining nut 20. As presented hereforeto, nozzle projection 10 comprises a first retention profile 19 and retaining nut 20 comprises second retention profile 26. The first retention profile 19 is of an appropriate geometry to engage upon second retention profile 26 such that the associated nozzle projection 10 can be mechanically traversed through retention nut 20. In a preferred embodiment, first retention profile 19 is comprised of threaded lands which engage upon continuous threaded grooves formed into second retention profile 26 (FIG. 12a); wherein nozzle projection 10 is essentially threaded through retaining nut 20 such that nozzle projection 10 extends through retaining nut shoulder 22. In an alternate embodiment, first retention profile 19 is comprised of lugs which engage laterally through notches defined through and forming discontinuous threaded grooves within the second retention profile 26 (FIG. 12b); wherein nozzle projection 10 is essentially slid through retaining nut 20 such that nozzle projection 10 extends through retaining nut shoulder 22. The thread pitch used in defining second retention profile 26 is the same as may be used or required in mounting a nozzle assembly 2 to a thermal melt extrusion head 50, and as such, the first retention profile 19 of the nozzle projection 10 may be the same pattern as used on a thermal melt extrusion head 50. In order to achieve a free axial rotation of nozzle projection 10, beneficial for establishing a desired flow pattern or direction by manual orientation of nozzle projection 10 on a thermal extrusion head 50, nozzle projection 10 is progressed past a point whereby first retention profile 19 is no longer engaged upon second retention profile 26. As nozzle projection 10 has progressed past the second retention profile 26 in retaining nut 20, and is prevented from displacing through retaining nut 20 due to impingement of nozzle retention flange 17 on retaining nut shoulder 22, nozzle orifice 12 can now be oriented in a desired flow direction without concern of de-coupling of nozzle assembly 2 or need for additional secondary retention means (i.e. spring clips).

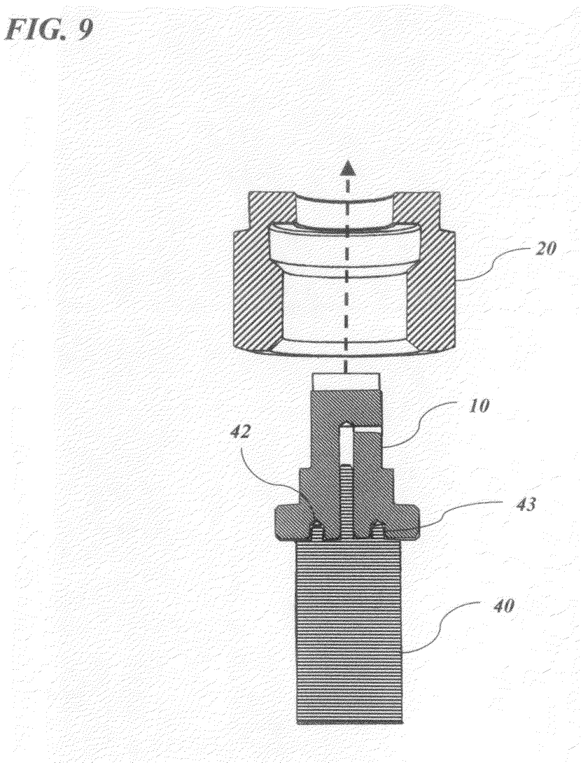

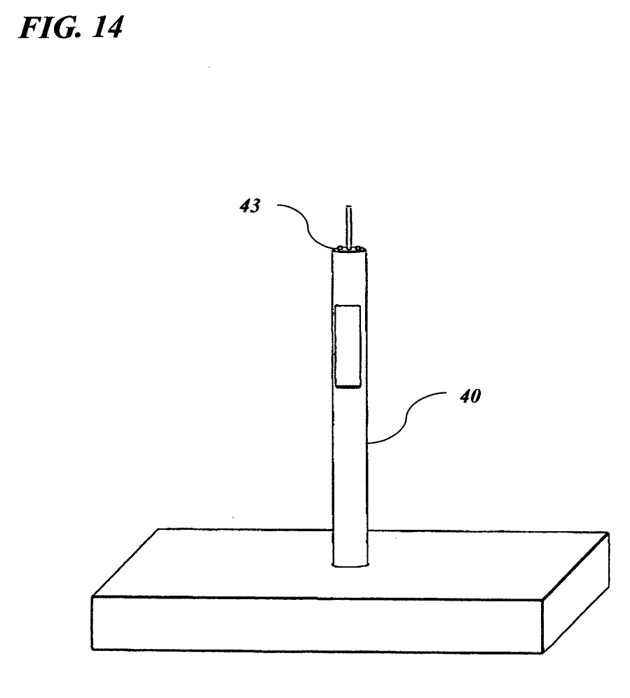

A method of combining nozzle projection 10 with retaining nut 20 to form a nozzle assembly 2 is detailed specifically in FIG. 6 through 12. Nozzle projection 10 is inserted into retaining nut 20 such that nozzle nose 11 extends through retaining shoulder 22 and first retention profile 19 engages upon second retention profile 26. Nozzle projection 10 is indexed through retaining nut 20 such that nozzle shoulder 14 then extends through retaining shoulder 22. Lastly, the nozzle projection 10 is moved past second retention profile 26 such that first retention profile 19 is received into free axial rotation chamber 24. For purposes of imparting a motive force on nozzle projection 10 so as to transverse retaining nut 20 second retention profile 26, an assembly tool 40 may be utilized. Assembly tool 40 may include one or more orientation features, which engage into axial flow tube 18 and/or into one or more optional mounting point 42 defined into the nozzle retention flange 17 (FIG. 9). Index features may include secondary extensions 43 (FIG. 9), specifically shaped protrusions, voids, or combinations thereof which can interface with assembly tool 40 and allow a user to move nozzle projection 10 into retaining nut 20 (i.e. assembly) or to move nozzle projection 10 out of retaining nut 20 (i.e. disassembly). A preferred embodiment as depicted in FIG. 9, includes an assembly tool 40 having a first forward extension which is inserted into axial flow tube 18 and two secondary extensions 43 which are inserted into corresponding positioned and shaped mounting point 42 in nozzle retention flange 17. Use of the assembly tool 40 embodiment in FIGS. 9 and 14, allows for nozzle projection 10 to be properly oriented to retaining nut 20 and torque to be applied by the user to the nozzle projection 10 by way of the inter-digitation of secondary extensions 43. Disassembly of a nozzle assembly 2 is performed by applying an initial force onto the nozzle projection 10 in the direction of the second retention profile 26. As nozzle projection 10 re-engages the associated first retention profile 19 into the second retention profile 26 of retaining nut 20, the nozzle projection 10 can be indexed out of free axial rotation chamber 24 and the nozzle assembly 2 returned to in primary components with need for reliance or removal of secondary retention means. It should be noted that in addition of, or the alternative to, use of assembly tool 40 in direct contact with retention flange 17 of nozzle projection 10, an assembly tool may provide a motive force for assembly and disassembly by interacting with nozzle nose 11, nozzle orifice 12, nozzle flat 15, nozzle orientation slot 16 and/or nozzle shoulder 14.

### EXAMPLE

I. Testing Platform

A hot melt adhesive extrusion device for evaluating differing nozzle assemblies was formed from a commercially available Nordson H200 hot-melt valve/gun well connected to a Nordson 3100 series hot-melt system by way of a standard single module manifold and hot-melt hose. The hot-melt system was filled with National Starch Insta Lok Type 34-2635 hot-melt adhesive having a listed viscosity of around 1150 cps at 350 degrees F., and as such the hot-melt system was set at during testing. The hot-melt system pressure was set at 600 psig and monitored continuously to ensure compliance with testing variables. For purposes of controlling a test dispense event, an electric timer was connected to an air solenoid drive controlling the H200 valve. The timer was set such that the valve was be open for exactly 5 seconds for each flow test. A 400 gram Ohaus Scout Pro electric scale linear to ±0.01 grams, a repeatability standard deviation of 0.01 grams, and having resolution of 0.01 grams was used to tare out disposable cups used to collect hot-melt flow samples, and to weigh the hot-melt flow samples after each dispense event by a test nozzle was dispensed into the aforementioned disposable cups.

II. Test Procedure: Thermal Melt Adhesive Flow Rate Performance

A test sample of thirteen (13) commercially hot-melt nozzles with a nozzle diameter of 0.018 inch and an engagement length of 0.050 inch (in accordance with U.S. Pat. No. 4,469,248 to Petrecca) were used as a control test samples for straight standard nozzle assemblies. Fourteen (14) nozzles in accordance with the present invention having a nozzle orifice 12 at an angle of 0 degrees from the axial flow tube 18 were fabricated, each having a nozzle diameter of 0.018 inch and an engagement length of 0.050 inch. Each nozzle in a sample was stamped in serial numeric order to ensure that each nozzle was tested properly (i.e. generate a single data point).

The commercially available control test assembly nozzles and the nozzle assemblies in accordance with the present invention were then evaluated sequentially utilizing the testing platform recited above as per the following procedure:
1. Place a nozzle assembly under evaluation on the H200 valve; alternating between the control and the present invention nozzle assemblies and progressing in numerical order.
2. Tighten the nozzle snuggly onto the valve with a ½″ wrench.
3. Tare out a paper disposable cup on the electric scale.
4. Place the tared disposable cup under the outlet of the nozzle assembly being tested.
5. Wait for at least 60 seconds for the nozzle to heat up to the temperature of the H200.
6. Activate the timer to dispense hot-melt adhesive into the cup for exactly 5 seconds.
7. Weigh the cup on the electronic scale for the “A” weight measurement for that nozzle assembly.
8. Record the “A” weight of the hot-melt adhesive that was dispensed into the cup.
9. Repeat with a duplicate “B” sample.
10. Remove tested nozzle assembly and repeat from Step 1.

III. Test Results—Thermal Melt Adhesive Flow Rate Performance

The average dispense weight for the thirteen (13) commercial nozzle assemblies tested in duplicate was 32.0 grams with a standard deviation of 0.42 grams. The average dispense weight for the fourteen (14) present invention nozzle assemblies was 33.7 grams with a standard deviation of 0.11 grams. The standard deviation of the flow/dispense weight measurements for the sample of commercial nozzle assemblies is 3.8 times larger than that for the present invention nozzle assemblies. A statistical analysis of variations or ANOVA on the test distributions showed that the standard deviations are not equal with a p-value being 0.024 for Levene's test. Based on this data, in order to attain a production process Cₚ of 1.33 for the commercial nozzles would require a short term hot-melt adhesive flow tolerance of ±5% where as a flow tolerance of only ±1.3% for the present invention nozzle assemblies is required s to achieve the same Cₚ. With regard to the flow rates reduction of the commercial nozzle assembly verses the present invention assembly, it is hypothesized that the use of a nozzle insert (as taught in the aforementioned U.S. Pat. No. 4,469,248 to Petrecca) resulted in increased flow restriction due to sharp transitions along the bore equivalent to the axial flow tube 18.

IV. Test Procedure: Nozzle Assembly Thermal Performance

This test is to measure the difference between a stabilized/settled temperature of three different 90 degree nozzles when fixed to a H200 type valve at a fixed temperature. The three nozzles was be two commercially available and procured assemblies (Keystone KNN9853, and an Indemax R2414) and one nozzle assembly in accordance with the present invention.

Two 84 ohm thin film Kapton heaters (0.5″×2.0″) were adhered to either side of an H200 type hot-melt valve and then covered with four (4) layers of standard duct tape as insulation. Both jaws of a vise are covered with four (4) layers of duct tape as insulation and then the spring adjustment nut of the valve was clamped in the vise to securely hold the valve at the end opposite to where the nozzle is attached by way of the ⅜″×24 threaded nose. The power leads for the heater were connected in parallel and then connected to a 24 VDC electrical power supply so as to provide approximately 13.5 Watts of heat to the valve module. The module was then allowed to reach temperature and equilibrate over the course of one hour. The stable valve temperature was measured by placing the end of a surface contact type K thermocouple on the exposed valve ball inside the threaded nose of the valve/gun. The output of the thermocouple was read by a “Traceable Total-Range Thermometer”, accurate to within ±1.8 degrees F. between −58 degrees F. and 1300 degrees F.).

The commercially available control test assembly nozzles and the nozzle assembly in accordance with the present invention were then evaluated sequentially utilizing the testing platform recited above, as per the following procedure:
1. Attach the 90 degree nozzle to the ⅜″×24 threaded nose of the H200 valve.
2. Snugly tighten the nozzle to the nose with a small ½″ wrench while holding the nozzle outlet pointing out horizontally to the right with a screwdriver.
3. Wait 4 minutes for the nozzle temperature to stabilize.
4. Measure the nozzle outlet temperature with the K type thermocouple.
5. Record this temperature with the nozzle name.
6. Measure the room temperature with the K type thermocouple.
7. Record and label the room temperature next to the nozzle temperature data.
8. Remove the nozzle from the H200 valve.
9. Repeat Step 1 with different nozzle assembly.

V. Test Results: Nozzle Assembly Thermal Performance

The H200 type valve nose temperature was measured to be 206 degrees F. before each nozzle assembly test. The nozzle outlet temperature of the present invention nozzle was measured to be 193 degrees F. with the room temperature being measured to be 71 degrees F. at the time of the test. The nozzle outlet temperature of the Keystone nozzle was measured to be 175 degrees F. with the room temperature being measured to be 71 degrees F. at the time of the test. The nozzle outlet temperature of the Indemax nozzle was measured to be 173 degrees F. with the room temperature being measured to be 72 degrees F. at the time of the test. The present invention nozzle had a temperature drop of 13 degrees F. relative to the nozzle nose temperature of the valve, thus representing 59% less temperature drop than the average temperature drop of 32° F. for both of the commercially available nozzle assemblies.

From the foregoing, it will be observed that numerous modifications and variations can be affected without departing from the true spirit and scope of the novel concept of the present invention. It is to be understood that no limitation with respect to the specific embodiments illustrated herein is intended or should be inferred. The disclosure is intended to cover, by the appended claims, all such modifications as fall within the scope of the claims.

What is claimed is:

1. A thermal melt nozzle assembly comprising;
a. a thermally conductive nozzle projection comprising a nozzle nose having an outer radius and at least one nozzle orifice, an axial flow tube having an inner radius in fluid communication with said nozzle orifice, a nozzle retaining flange, wherein said retaining flange further comprises a first retention profile;
b. a retaining nut comprising a retaining nut shoulder, a free axial rotation chamber and a second retention profile;
wherein said nozzle nose exhibits a ratio of nozzle nose length to nozzle nose radius of greater than two to one;
wherein said first retention profile is engaged upon said second retention profile such that said nozzle projection extends through said retaining nut shoulder during assembly and disassembly of the thermal melt nozzle; and,
wherein said nozzle projection can rotate freely when said first retention profile is located within said free axial rotation chamber.

2. A thermal melt nozzle assembly as in claim 1, wherein said nozzle orifice exhibits a departure angle of 0 to 135 degrees from the axis defined by said axial flow tube.

3. A thermal melt nozzle assembly as in claim 1, wherein said nozzle orifice exhibits a departure angle of 90 degrees from the axis defined by said axial flow tube.

4. A thermal melt nozzle assembly as in claim 1, wherein said nozzle retention flange can rotate freely when said first retention profile is located between said retaining nut shoulder and said second retention profile.

5. A thermal melt nozzle assembly as in claim 1, wherein said nozzle retention flange further comprises one or more assembly tool mounting points.

6. A thermal melt nozzle assembly as in claim 1, wherein said nozzle projection further comprises one or more assembly tool mounting points.

7. A thermal melt nozzle assembly as in claim 6, wherein said assembly tool mounting point is an orientation slot.

8. A thermal melt nozzle assembly as in claim 1, wherein said nozzle nose has an outer radius of less than ten (10) times said axial flow tube inner radius.

9. A thermal melt nozzle assembly as in claim 1, wherein said axial flow tube inner radius in the range of 0.0075 inch to 0.05 inch and said nozzle nose has an outer radius in the range of between 0.075 inch and 0.50 inch.

10. A thermal melt nozzle assembly as in claim 1, wherein said nozzle nose has an outer radius of less than eight (8) times said axial flow tube inner radius.

11. A thermal melt nozzle assembly as in claim 1, wherein said axial flow tube inner radius in the range of 0.015 inch to 0.05 inch and said nozzle nose has an outer radius in the range of between 0.12 inch and 0.40 inch.

12. A thermal melt nozzle assembly as in claim 1, wherein said nozzle assembly exhibits a nozzle nose exit temperature loss of less than 10% of a thermal melt extrusion head temperature.

13. A thermal melt nozzle assembly comprising;
a. a thermally conductive nozzle projection comprising a nozzle nose having an outer radius and at least one nozzle orifice and an axial flow tube having an inner radius in fluid communication with said nozzle orifice,
b. a retaining nut comprising a means to attach a thermal conductive nozzle projection to a thermal melt extrusion head,
wherein said nozzle nose exhibits a ratio of nozzle nose length to nozzle nose radius of greater than two to one and an outer radius less than eight (8) times said axial flow tube inner radius.

14. A thermal melt nozzle assembly as in claim 13, wherein said nozzle assembly exhibits a nozzle nose temperature loss of less than 10% of a thermal melt extrusion head temperature.

15. A thermal melt nozzle assembly as in claim 13, wherein said nozzle projection further comprises a nozzle retention flange having a first retention profile and said retaining nut further comprises a second retention profile and an adjoining free axial rotation chamber.

16. A thermal melt nozzle assembly as in claim 15, wherein said first retention profile is engaged upon said second retention profile such that said nozzle projection extends through said retaining nut shoulder during assembly and disassembly.

17. A thermal melt nozzle assembly as in claim 16, wherein said nozzle projection can rotate freely when said first retention profile is located within said free axial rotation chamber.

18. A method for assembling a thermal melt nozzle assembly comprising;
a. obtaining a thermally conductive nozzle projection comprising a nozzle nose having an outer radius and at least one nozzle orifice, an axial flow tube having an inner radius in fluid communication with said nozzle orifice, and a nozzle retaining flange, wherein said retaining flange further comprises a first retention profile;
b. obtaining a retaining nut comprising a retaining nut shoulder, a free axial rotation chamber and a second retention profile;
c. inserting said nozzle projection into said retaining nut such that said first retention profile is engaged upon said second retention profile such that said nozzle projection extends through said retaining nut shoulder;
d. moving said nozzle projection through said retaining nut until said first retention profile of said nozzle projection disengages from said second retention profile and into said free axial rotation chamber;
wherein said nozzle nose exhibits a ratio of nozzle nose length to nozzle nose radius of greater than two to one; and, wherein said nozzle projection can rotate freely about an axis defined by said axial flow tube.

19. A method for nozzle assembly as in claim 18, wherein said nozzle projection further comprises assembly tool mounting points.

20. A method for nozzle assembly as in claim 19, wherein said method further comprises use of an assembly tool to move said nozzle projection through said retaining nut.
